(19) United States
(12) Patent Application Publication
(10) Pub. No.: US 2009/0296536 A1
(43) Pub. Date: Dec. 3, 2009

(54) MAGNETIC DISK DEVICE

(75) Inventor: Makoto Nagai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/357,871

(22) Filed: Jan. 22, 2009

(30) Foreign Application Priority Data
Jun. 2, 2008 (JP) 2008-144998

(51) Int. Cl. G11B 11/00

(52) U.S. Cl. 369/13.24; G9B/11

(57) ABSTRACT

The magnetic disk device is capable of securely removing contaminations from an outer face of a magnetic head, maintaining superior recording and reproducing characteristics and improving reliability. The magnetic disk device comprises: a ramp for holding a magnetic head at an evacuating position, the ramp being located outside of a region in which a magnetic recording medium is provided; and a laser emitting section for emitting a laser beam toward the magnetic head so as to heat the magnetic head, the laser emitting section being located in a moving track of the magnetic head, which is moved between the evacuating position and a loading position, without interfering with the magnetic head. An air stream generated by rotation of the magnetic recording medium removes contaminations from the magnetic head when the magnetic head is loaded.

### BACKGROUND

The present invention relates to a magnetic disk device, more precisely relates to a magnetic disk device having a mechanism for cleaning a magnetic head.

In a magnetic disk device, a magnetic recording medium is rotated at high speed, and data are read and written by a magnetic head. The magnetic head is supported by an actuator arm and swung over the magnetic recording medium. In an unloading state, the magnetic head is evacuated to, for example, a ramp located outside of a region in which the magnetic recording medium is provided. The ramp includes a holding section capable of holding the magnetic head. The holding section holds a hook of a head suspension, on which the magnetic head is mounted, so that the magnetic head can be held at an evacuating position.

Surfaces of the magnetic recording medium are coated with lubricant, and the lubricant will stick onto an air bearing surface (ABS) of the magnetic head. Further, lubricant of rotating parts, e.g., motor, bearing, will be spattered in a casing of the magnetic disk device and stick onto an outer face of the magnetic head.

A floating pattern, which is a concavo-convex pattern, is formed in the ABS of the magnetic head, and it is known that contaminations, e.g., lubricant, will easily stick, especially, in the concave parts of the pattern.

In a recent magnetic disk device, data can be high-densely recorded, and a floating height of the magnetic head from a surface of a magnetic recording medium is very low. Namely, a clearance between the surface of the magnetic recording head and the ABS of the magnetic head is very small. Therefore, the floating height of the magnetic head must be highly precisely controlled. If contaminations stick on the ABS of the magnetic head, the floating height will be varied. By the variation of the floating height, recording and reproducing characteristics of the magnetic head will be worsened. Thus, providing a mechanism for cleaning the magnetic head of the magnetic disk device has been studied. Some magnetic devices having cleaning mechanisms are disclosed in, for example, Japanese Laid-open Patent Publications No. 2006-302412 and No. 11-195213.

However, in the conventional cleaning mechanisms, an outer face of a magnetic head is brought into contact with a cleaning pad so as to remove contaminations, but the contamination cannot be securely removed and the contaminations will be transferred from the cleaning pad to the magnetic head. Further, in case of bringing the magnetic head into contact with the cleaning pad, the magnetic head repeatedly brought into contacts the cleaning pad, so the magnetic head will be damaged.

### SUMMARY

The present invention was conceived to solve the above described problems.

An object of the present invention is to provide a highly reliable magnetic disk device, which is capable of securely removing contaminations from an outer face of a magnetic head and maintaining superior recording and reproducing characteristics.

To achieve the object, the present invention has following structures.

Namely, A first basic structure of the magnetic disk device of the present invention comprises: a ramp for holding a magnetic head at an evacuating position, the ramp being located outside of a region in which a magnetic recording medium is provided; and a laser emitting section for emitting a laser beam toward an outer face of the magnetic head so as to heat the outer face thereof, the laser emitting section being located in a moving track of the magnetic head, which is moved between the evacuating position and a loading position at which the magnetic head is loaded on the magnetic recording medium, without interfering the moving action of the magnetic head, and an air stream generated by rotation of the magnetic recording medium removes a contamination on the outer face of the magnetic head when the magnetic head is loaded on the magnetic recording medium.

A second basic structure of the magnetic disk device of the present invention comprises: a ramp for holding a magnetic head at an evacuating position, the ramp being located outside of a region in which a magnetic recording medium is provided; a laser emitting section for emitting a laser beam toward an outer face of the magnetic head so as to heat the outer face thereof, the laser emitting section being located at the evacuating position; an air inlet for introducing an air stream, which is generated by rotation of the magnetic recording medium, to the ramp; and an air outlet for discharging the air, which has been introduced to the ramp, toward the outer face of the magnetic head held at the evacuating position.

In the second basis structure, the magnetic disk device may include one or a plurality of the magnetic recording mediums, a plurality of the magnetic heads may be respectively loaded on the both surfaces of each of the magnetic recording mediums, and a plurality of the air inlets may be respectively provided in the vicinity of the upper and lower edges of each of the magnetic recording mediums. With this structure, the air stream generated by the rotation of the magnetic recording medium can be efficiently introduced into the air inlets, so that the contaminations on the outer face of the magnetic head can be effectively removed.

In each of the basic structures, the magnetic disk device may include a plurality of the magnetic recording mediums, a plurality of the magnetic heads may be respectively provided for the magnetic recording mediums, and a plurality of the laser emitting sections may be respectively provided for the magnetic heads. With this structure, the contaminations can be effectively removed.

In each of the basic structures, the magnetic disk device may include one or a plurality of the magnetic recording mediums, a plurality of the magnetic heads may be respectively loaded on the both surfaces of each of the magnetic recording mediums, and the air inlet may be provided for each pair of the magnetic heads to be loaded on each of the magnetic recording mediums. With this structure, the magnetic heads to be loaded on the both surfaces of the magnetic recording medium can be suitably cleaned.

In each of the basic structures, a laser emitting range of the laser emitting section may be designed to irradiate an entire air bearing surface of the magnetic head when the magnetic head is moved across the laser emitting section.

In the magnetic disk device of the present invention, the outer face of the magnetic head is heated by the laser beam, and the magnetic head is cleaned by using the air stream generated by the rotation of the magnetic recording medium. Therefore, contaminations can be securely removed from the magnetic head without damaging the magnetic head. Even if the magnetic head is located at the evacuating position, the air stream generated by the rotation of the magnetic recording medium can be introduced through the air inlet and discharged toward the magnetic head, so that contaminations can be effectively removed. By removing contaminations from the outer face of the magnetic head, varying the floating height of the magnetic head can be restrained and the reliability of the magnetic disk device can be improved.

### BRIEF DESCRIPTION OF THE DRAWINGS

Embodiments of the present invention will now be described by way of examples and with reference to the accompanying drawings, in which:

FIG. 1 is a plan view of a magnetic disk device of a first embodiment of the present invention;

FIGS. 2A and 2B are explanation views showing actions for cleaning a magnetic head;

FIGS. 3A-3C are explanation views showing an inner structure of a laser emitting section;

FIG. 4 is a plan view of the magnetic disk device having another heating/cleaning mechanism;

FIG. 5 is a plan view of a magnetic disk device of a second embodiment of the present invention;

FIG. 6 is an explanation view of a cleaning mechanism of the second embodiment;

FIGS. 7A-7C are explanation views of examples of the laser emitting section;

FIG. 8 is a plan view of a magnetic disk device of a third embodiment of the present invention;

FIG. 9 is a plan view showing a ramp and a laser emitting section of the third embodiment;

FIG. 10 is an explanation view showing an arrangement of the laser emitting section, a magnetic head, etc. when the magnetic head is located at an evacuating position;

FIG. 11 is a partial perspective view of the ramp; and

FIGS. 12A-12C are explanation views of the ramp, which is capable of moving between a cleaning position and the evacuating position.

### DETAILED DESCRIPTION OF THE EMBODIMENTS

Preferred embodiments of the present invention will now be described in detail with reference to the accompanying drawings.

### First Embodiment

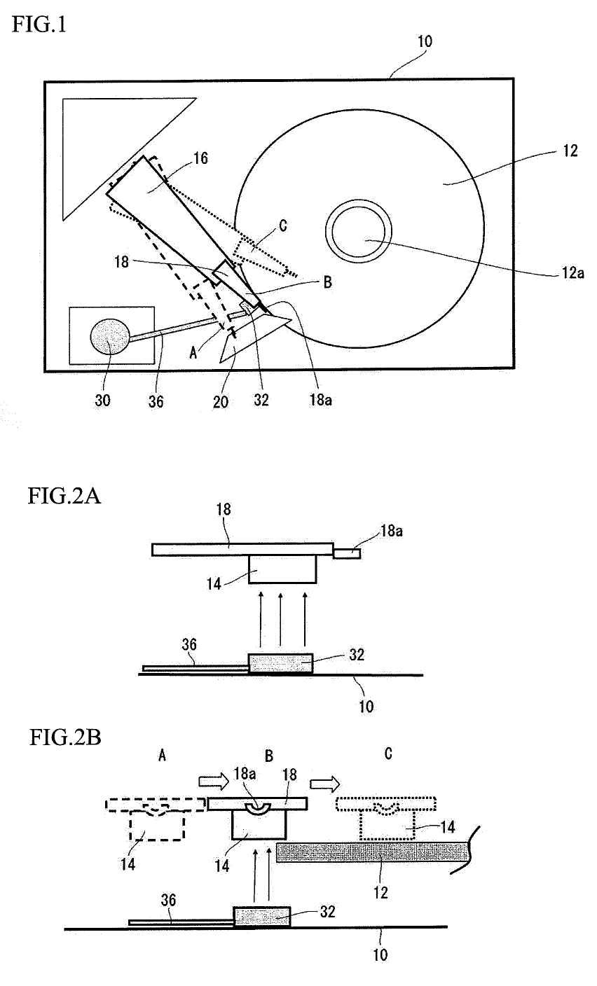

FIG. 1 is a plan view of a magnetic disk device of a first embodiment of the present invention.

The magnetic disk device of the present embodiment is encased in a box-shaped casing 10 having a rectangular planar configuration. A magnetic recording medium 12, i.e., magnetic disk, and an actuator arm 16, which supports a magnetic head 14 for recording data in and reproducing data from the magnetic recording medium 12, are provided in the casing 10.

In the present embodiment, one magnetic recording medium 12 is attached to a rotary shaft 12a and rotated, in a prescribed direction, by a spindle motor.

A rear end of the actuator arm 16 is pivotably attached at a position sidewardly separated from the magnetic recording medium 12. The actuator arm 16 is swung, by an actuator (not shown), in a plane parallel to an upper surface of the magnetic recording medium 12.

A head suspension 18 is attached to a front end of the actuator arm 16, and a hook 18a, which holds the head suspension 18 at an evacuating position, is provided to a front end of the head suspension 18.

The magnetic head 14, which has an air bearing surface (ABS) facing the magnetic recording medium 12, is mounted on the front end of the head suspension 18. In FIG. 1, the magnetic head 14 is provided on the lower face of the head suspension 18 (see FIGS. 2A and 2B), so it is not shown. In the magnetic disk device of the present embodiment, the magnetic head 14 is evacuated to a position located outside of a region, in which the magnetic recording medium 12 is provided, when the magnetic head 14 is unloaded.

A ramp 20 is formed on the outer side of an outer edge of the magnetic recording medium 12 so as to evacuate the magnetic head 14. An engaging section, which is capable of engaging with the hook 18a of the head suspension 18, is provided to the ramp 20 so as to hold the magnetic head 14 at the evacuating position.

In a state “A” shown in FIG. 1, the hook 18a is engaged with the ramp 20, and the magnetic head 14 is located at the evacuating position. In a state “B”, the actuator arm 16 is moved, from the ramp 20 toward the magnetic recording medium 12, together with the magnetic head 14. A state “C” shows a loading state, in which the magnetic head 14 is on the magnetic recording medium 12.

The magnetic disk device of the present embodiment is characterized in that a heating/cleaning mechanism heats and cleans an outer face of the magnetic head, e.g., ABS, by laser beams when the actuator arm 16 is in the shown state “B”.

The heating/cleaning mechanism includes: a laser source 30; a laser emitting section 32 for emitting laser beams toward the magnetic head 14; and laser guide means 36, e.g., optical fiber, connecting the laser source 30 to the laser emitting section 32. For example, a semiconductor laser element may be employed as the laser source 30.

The laser emitting section 32 is provided in a moving track of the magnetic head 14 between the evacuating position and a loading position at which the magnetic head 14 is loaded on the magnetic recording medium 12, i.e., the outer edge of the magnetic recording medium 12, and is capable of emitting laser beams toward the magnetic head 14. Actually, the ramp 20 is located in the vicinity of the outer edge of the magnetic recording medium 12 so as to efficiently load and unload the magnetic head 14.

In FIG. 2A, the laser emitting section 32 is located under the moving track of a head slider including the magnetic head 14, which is held by the head suspension 18. The laser emitting section 32 is provided on an inner bottom face of the casing 10. In FIG. 2B, the magnetic head 14 is moved across the laser emitting section 32 with changing the state from “A” to “C” shown in FIG. 1. While changing the state from “A” to “C”, the laser emitting section 32 emits laser beams toward the magnetic head 14.

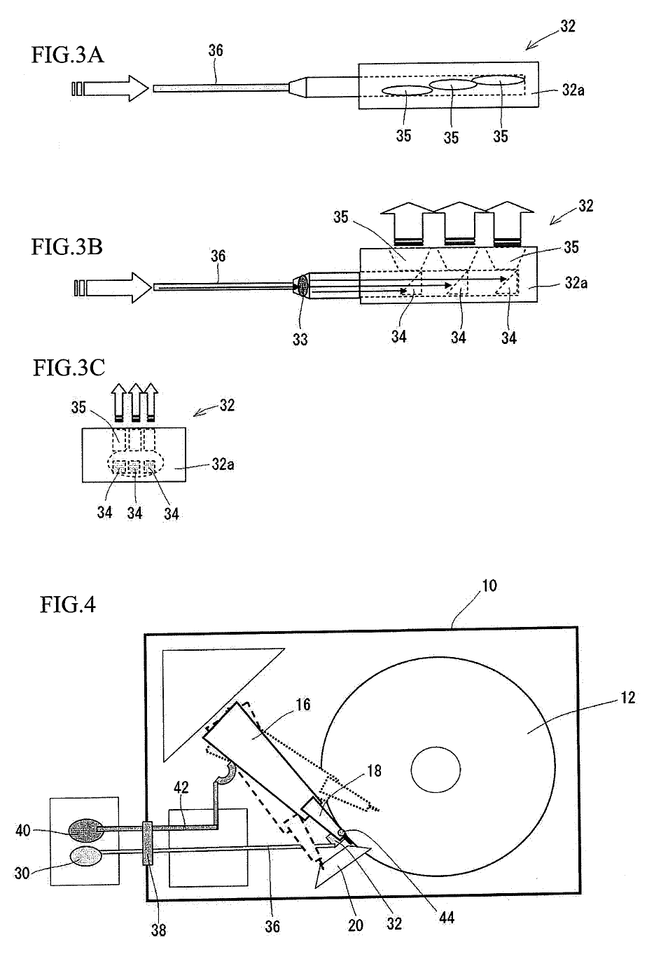

FIGS. 3A-3B show an inner structure of the laser emitting section 32. As shown in FIG. 3B, a laser beam, which has been introduced from the laser source 30 to the laser emitting section 32 via the laser guide means 36, is diffused by a lens 33, and the diffused laser beam is introduced into a main body section 32a of the laser emitting section 32 by an optical fiber. Mirror or prisms 34 for reflecting the diffused laser beam are provided in the main body section 32a. Reflected laser beams, which have been reflected by the mirrors or prisms 34, are emitted through opening sections 35, which are opened in an upper face of the main body section 32a.

FIG. 3A is a plan view of the laser emitting section 32a, the reflected laser beams, which have been reflected by the mirrors or prisms 34, are emitted in the form of three connected ellipses.

FIG. 3C is a right side view of the laser emitting section 32. The reflected laser beams seen from the right side are like narrow beams.

Emitting regions of the reflected laser beams, which are emitted from the laser emitting section 32, are elongated in the direction perpendicular to the moving direction of the magnetic head 14. Therefore, the reflected laser beams can sweep the ABS of the magnetic head 14 while the magnetic head 14 is moved from the ramp 20 to the magnetic recording medium 12. In FIGS. 3A and 3B, a long axis of each of the elliptical emitting regions of the reflected laser beams is longer than a longitudinal length of the head slider. With this structure, the entire ABS of the magnetic head 14 can be irradiated or swept with the reflected laser beams while the magnetic head 14 is moved from the ramp 20 to the magnetic recording medium 12.

Note that, in case of removing contaminations sticking only in the periphery of a read/write element of the magnetic head 14 where contaminations easily stick, the laser emitting section 32 may emit the reflected laser beams toward only the periphery of the element of the magnetic head 14.

Contaminations, e.g., lubricant, sticking on the outer face of the magnetic head 14 can be softened at relatively low temperature. For example, lubricant can be softened at 40-60 □. While the actuator arm 16 is moved from the ramp 20 to the magnetic recording medium 12, even if the laser emitting section 32 emits the reflected laser beams toward the magnetic head 14 in a short time, the outer face of the magnetic head 14 can be heated until reaching a prescribed temperature by controlling a power of the laser beam. Note that, the reflected laser beams mainly irradiate the ABS of the outer face of the magnetic head 14. Further, other parts of the outer face of the magnetic head 14 can be heated by the reflected laser beams depending on the emitting directions of the reflected laser beams, the configuration of the magnetic head 14, etc..

When the magnetic head 14, whose outer face has been heated by the laser emitting section 32, is moved onto the magnetic recording medium 12, contaminations sticking on the outer face of the magnetic head 14, especially ABS, are spattered and removed therefrom by an air stream or wind pressure generated by rotation of the magnetic recording medium 12. Since the contaminations are removed from the outer face of the magnetic head 14 by the air stream or the wind pressure, the magnetic head 14 must be heated to the prescribed temperature for easily removing the contaminations by the air stream generated by the rotation of the magnetic recording medium 12. The prescribed temperature may be optionally set, but it is usually higher than an environmental temperature of the magnetic disk device.

The heating/cleaning mechanism of the present embodiment cleans the magnetic head 14 every time the magnetic head 14 is loaded. Therefore, the magnetic head 14 records or reproduces data after cleaning the outer face of the magnetic head 14, e.g., ABS, each time. The action of moving the magnetic head 14 from the evacuating position to the loading position on the magnetic recording medium 12 is performed every time, so the clean state of the magnetic head 14 can be always maintained.

By operating the magnetic disk device, contaminations will be generated, in the casing 10, from some parts other than the magnetic recording medium 12, but such contaminations can be also removed every time the magnetic head 14 is loaded.

Even if the contaminations, e.g., lubricant, stick onto the ABS of the magnetic head 14, they can be removed by the heating/cleaning mechanism, so that a suitable floating characteristic of the magnetic head 14 can be maintained and recording/reproducing reliability of the magnetic head 14 can be improved.

FIG. 4 shows the magnetic disk device having another heating/cleaning mechanism. In the magnetic disk device, the laser source 30 is provided outside of the casing 10, and the laser source 30 is connected to the laser emitting section 32 by the laser guide means 36. The structure of the laser emitting section 32 is the same as that shown in FIG. 1.

The magnetic disk device shown in FIG. 4 is an example having a thermal assist mechanism, which locally heats when signals are written in the magnetic recording medium 12. The thermal assist mechanism locally emits a laser beam from the magnetic head 14 toward the magnetic recording medium 12. In FIG. 4, the thermal assist mechanism has a laser source 40, and the laser beam is introduced from the laser source 40 to the magnetic head 14 by laser guide means 42.

In case of using the laser thermal assist mechanism, the laser source 40 may be used instead of the laser source 30 of the heating/cleaning mechanism. In case of using the laser source 40 for the both purposes, the laser power is controlled for the thermal assist and the heating/cleaning mechanism, so that the cleaning action can be performed when the magnetic head 14 is loaded onto the magnetic recording medium 12.

In the present embodiment, the laser source 30 is connected to the laser emitting section 32 by the laser guide means 36. Further, the laser means for heating the magnetic head 14, e.g., semiconductor laser element, may be provided in the laser emitting section 32. In case of irradiating only the periphery of the element of the magnetic head 14, the laser emitting section 32 may include a mere laser element.

### Second Embodiment

FIG. 5 is a schematic plan view of a magnetic disk device of a second embodiment of the present invention. Note that, the structural elements described in the first embodiment are assigned the same reference symbols and explanation will be omitted.

In the second embodiment, data are recorded on the both surfaces of the magnetic recording medium 12, so the magnetic disk device has a plurality of the actuator arms 16. The heating/cleaning mechanism cleans a plurality of the magnetic heads 14 which are respectively held by the actuator arms 16.

In the present embodiment too, the heating/cleaning mechanism comprises: the laser source 30; the laser emitting section 32 for emitting laser beams toward the magnetic heads 14; and the laser guide means 36, e.g., optical fiber, connecting the laser source 30 to the laser emitting section 32. The ramp 20 is capable of holding the magnetic head 14 at the evacuating position (unloading position) as well as the first embodiment.

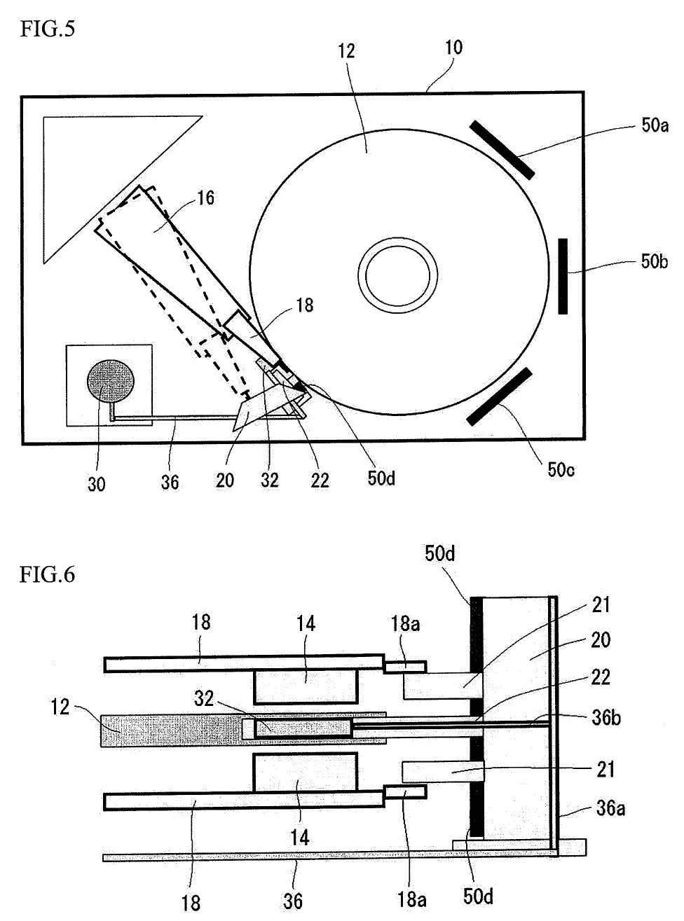

The heating/cleaning mechanism for heating and cleaning the ABSs of the magnetic heads 14, which respectively faces the both surfaces of the magnetic recording medium 12, is shown in FIG. 6.

The ramp 20, which is located at the evacuating position of the magnetic head 14, has engaging sections 21, with which the hooks 18a of the head suspensions 18 supporting the magnetic heads 14 can be engaged. The engaging sections 21 are separately arranged in the height direction. The heights of the engaging sections 21 respectively correspond to those of the head suspensions 18, which respectively support the magnetic heads 14.

In FIG. 6, the magnetic heads 14 are provided for the lower and upper surfaces of one magnetic recording medium 12. Further, in case of using a plurality of the magnetic recording mediums 12, the magnetic heads 14 are provided for the lower and upper surfaces of each of the magnetic recording mediums 12. Therefore, the engaging sections 21, whose heights are respectively corresponded to those of the head suspensions 18 supporting the magnetic heads 14, are provided in the ramp 20.

In the present embodiment, the laser emitting section 32 is capable of simultaneously emitting laser beams toward a pair of the magnetic heads 14 which are assigned to each of the magnetic recording mediums 12. Since a prescribed clearance is formed between the ABSs of the pair of magnetic heads 14 supported by the head suspensions 18, the laser emitting section 32 is provided in the clearance.

In the present embodiment, a supporting arm 22 is extended, from the ramp 20, in the clearance between the magnetic heads 14 which are supported by the ramp 20 and faced each other, and the laser emitting section 32 is provided to the supporting arm 22. A height of the laser emitting section 32 is designed so as not to interfere with the outer faces of the magnetic heads 14. The ABSs of the magnetic heads 14 are moved across the laser emitting section 32 when the magnetic heads 14 are loaded.

The laser source 30 is connected to the laser emitting section 32 by: the laser guide means 36 being provided on the inner bottom face of the casing 10; laser guide means 36a being connected to the laser guide means 36 and vertically arranged along the ramp 20; and laser guide means 36b being branched from the laser guide means 36a, arranged along the supporting arm 22 and connected to the laser emitting section 32.

In case of using a plurality of the magnetic recording mediums 12 and loading the magnetic heads 14 onto the lower and upper surfaces of each of the magnetic recording mediums 12, a plurality of the laser emitting sections 32, which are connected to the laser source 30, may be respectively provided for the magnetic recording mediums 12.

The laser emitting section 32 is capable of emitting laser beams toward the both magnetic heads 14 when the magnetic heads 14 are moved across the laser emitting section 32.

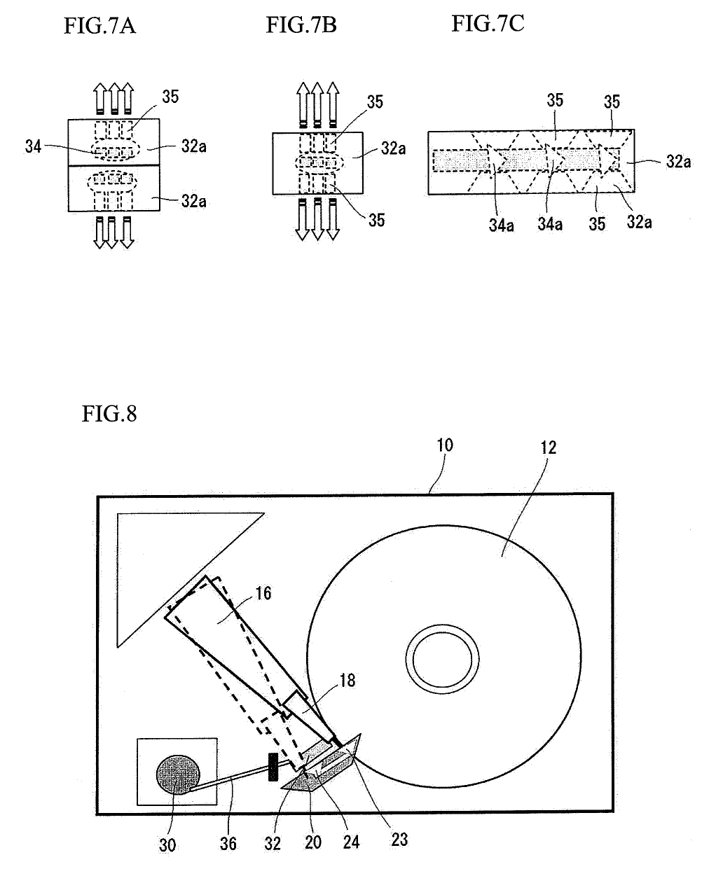

In FIG. 7A, two laser emitting sections 32, each of which is the same as the laser emitting section 32 shown in FIG. 3, are vertically layered. The upper laser emitting section 32 emits laser beams upward; the lower laser emitting section 32 emits laser beams downward. The laser emitting sections 32 are capable of simultaneously emitting laser beams toward the pair of magnetic heads 14.

In FIGS. 7B and 7C, the opening sections 35 are formed in the upper face and the lower face of the main body section 32a of the laser emitting section 32. The laser beam introduced into the laser emitting section 32 is reflected upward and downward by mirrors or prisms 34a, so that the reflected laser beams are emitted from the laser emitting section 32 toward the both magnetic heads 14.

In the present embodiment too, the laser beam is diffused in the laser emitting section 32, the laser beam is reflected as reflected laser beams, and an entire longitudinal range of the magnetic heads 14 is covered with the emitting regions of the reflected laser beams, as well as the first embodiment.

In the magnetic disk device of the present embodiment, the laser emitting section 32 emits the reflected beams toward the both magnetic heads 14 so as to heat the outer faces thereof while the magnetic heads 14 are moved from the ramp 20 to the magnetic recording medium 12. By heating the magnetic heads 14, contaminations sticking on the outer faces of the magnetic heads 14 are softened. Therefore, the contaminations are spattered by air streams or wind pressure generated by the rotation of the magnetic recording medium 12 when the magnetic heads 14 are loaded onto the magnetic recording medium 12, so that the outer faces of the magnetic heads 14 can be cleaned. The magnetic heads 14, which are respectively loaded on the lower and upper surfaces of the magnetic recording medium 12, can be equally cleaned.

In case that the magnetic heads 14 are loaded onto the both surfaces of the magnetic recording medium 12, the magnetic heads 14 can be cleaned by the laser emitting section 32, so that data can be read and reproduced by the cleaned magnetic heads 14 every time.

In case that the magnetic disk device includes a plurality of the magnetic recording mediums 12 and the magnetic head 14 is loaded onto one surface of each of the magnetic recording mediums 12, a plurality of the laser emitting sections 32 shown in FIG. 3, each of which emits the reflected laser beams from one side, may be vertically arranged, and their heights correspond to those of the magnetic heads 14. Each of the laser emitting sections 32 is provided in the moving track of each of the magnetic heads 14 so as to sweep the outer face, e.g., ABS, of each of the magnetic heads 14 with the reflected laser beams.

As shown in FIG. 5, filters 50a, 50b and 50c for filtering and collecting the contaminations, e.g., lubricant, which have been spattered from the magnetic head 14, are provided, as contamination collecting members, along the outer edge of the magnetic recording medium 12. The contaminations sticking on the magnetic head 14 are spattered when the magnetic head 14 is moved to the outer edge of the magnetic recording medium 12, so it is effective to provide the filters 50a, 50b and 50c close to the outer edge of the magnetic recording medium 12.

In FIG. 6, a filter 50d is provided on a side face of the ramp 20 as a contamination collecting member. The ramp 20 is located close to the outer edge of the magnetic recording medium 12 and located on the downstream side, in the rotational direction of the magnetic recording medium 12, with respect to the magnetic head 14. Therefore, it is effective to provide the filter 50d on the side face of the ramp 20.

The filters 50a, 50b, 50c and 50d are composed of an absorbing material, which is capable of absorbing contaminations, e.g., lubricant, without scattering therefrom, so as not to contaminate the inner structure of the magnetic disk device.

### Third Embodiment

FIG. 8 is a schematic plan view of a magnetic disk device of a third embodiment of the present invention. Note that, the structural elements described in the first and second embodiments are assigned the same reference symbols and explanation will be omitted.

The heating/cleaning mechanism of the present embodiment is capable of heating and cleaning the magnetic head 14 while the magnetic head 14 is located at the evacuating position. Therefore, the laser emitting section 32 is provided to the ramp 20. When the magnetic head 14 reaches the ramp 20, the ABS of the magnetic head 14 is heated. The laser source 30 is connected to the laser emitting section 32 by the laser guide means 36.

In the present embodiment, the ramp 20 has air inlets 23 for introducing the air stream, which is generated by the rotation of the magnetic recording medium 12, and an air outlet 24 for discharging the air toward the ABS of the magnetic head 14 locating at the evacuating position.

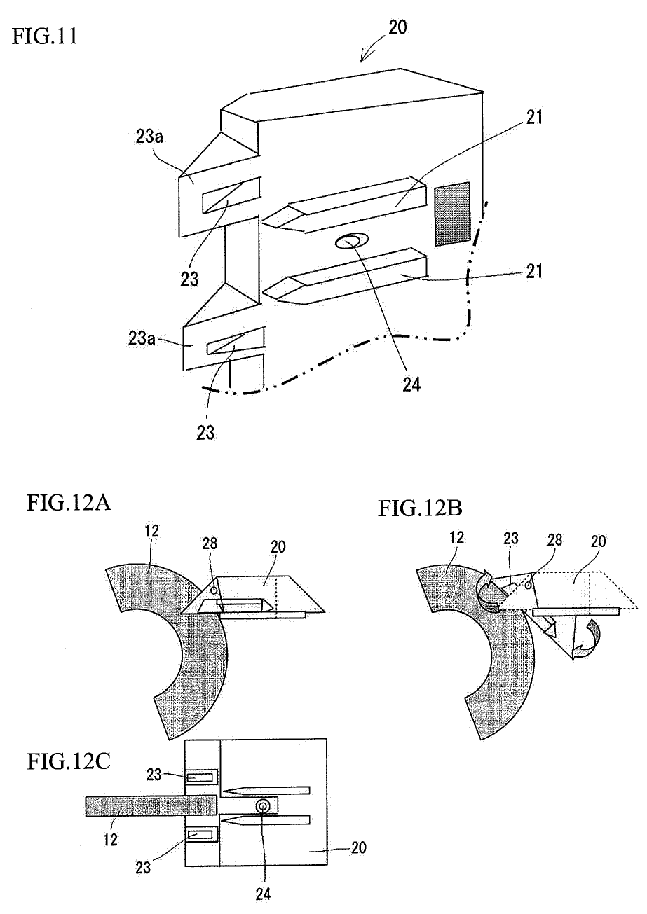

A partial perspective view of the ramp 20 is shown in FIG. 11. Air inlet sections 23a are projected, toward the outer edge of the magnetic recording medium 12, from the side face of the ramp 20, which faces the magnetic recording medium 12. The air inlet sections 23a are formed on the inflow side of the ramp 20 so as to introduce the air stream, which is generated by the rotation of the magnetic recording medium 12, into the air inlets 23. The magnetic recording medium 12 is provided in a space between a pair of the air inlet sections 23a, as shown. The air inlets 23 are respectively formed in the air inlet sections 23a.

The engaging sections 21 for engaging the hooks 18a of the head suspensions 18 are formed in a front face of the ramp 20. Slope faces are formed in front parts of the engaging sections 21, which are located on the magnetic recording medium 12 side. When the magnetic heads 14 are moved from the loading position on the magnetic recording medium 12 to the evacuating position, the hooks 18a of the head suspensions 18 are guided to the engaging sections 21 by the slope faces. When the hooks 18a contact the engaging sections 21, the magnetic heads 14 are held at the evacuating positions. The engaging sections 21, which are vertically separately formed in the ramp 20, are provided for each of the head suspensions 18 supporting the magnetic heads 14.

The air outlet 24 is formed between the pair of engaging sections 21 and corresponded to the evacuating position of the magnetic head 14. The pair of air inlets 23 for each of the magnetic recording medium 12 are communicated to the air outlet 24 via air paths formed in the ramp 20.

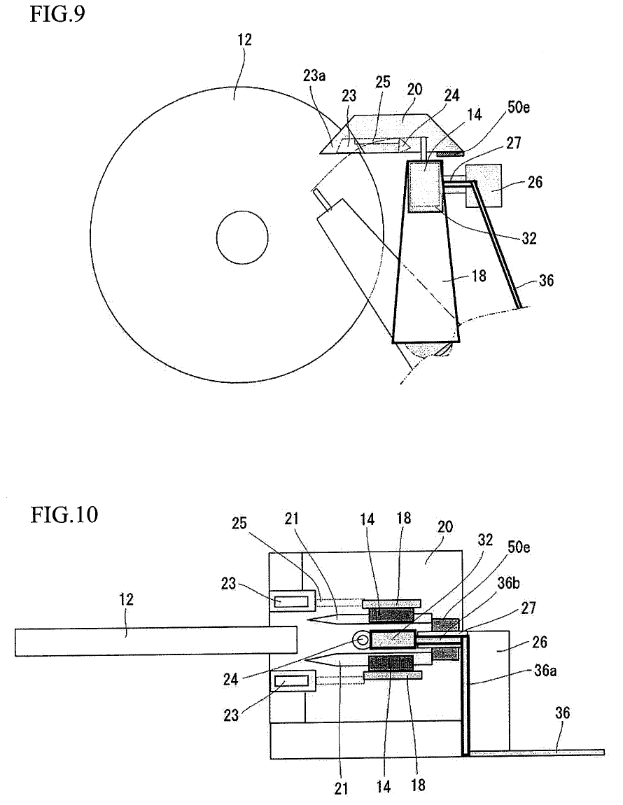

FIG. 9 shows planar arrangement of the ramp 20 and the laser emitting section 32.

The air inlet sections 23a of the ramp 20 are extended beyond the outer edge of the magnetic recording medium 12, and the air inlets 23 are communicated to the air outlet 24 via the air paths 25.

The laser emitting section 32 is located under the magnetic head 14, which is supported by the head suspension 18 and located at the evacuating position. The laser emitting section 32 is supported by a stud 26, which is fixed on the inner bottom face of the casing 10, and a supporting arm 27, which is extended from the stud 26.

FIG. 10 shows a positional relationship between the laser emitting section 32, the magnetic heads 14, the air inlets 23 and the air outlet 24 in the ramp 20.

The laser emitting section 32 is located between the pair of magnetic heads 14, without interfering therewith, when the head suspensions 18 are engaged with the engaging sections 21 and the ABSs of the magnetic heads 14 are mutually faced.

The laser source 30 is connected to the laser emitting section 32 by the laser guide means 36, which is provided on the inner bottom face of the casing 10, the laser guide means 36a, which is vertically provided along the stud 26, and the laser guide means 36b, which is supported by the supporting arm 27.

In FIG. 10, the laser emitting section 32 is provided for one magnetic recording medium 12. In case of using a plurality of the magnetic recording mediums 12, a plurality of the laser emitting sections 32, which respectively correspond to the magnetic recording mediums 12, may be provided to the stud 26.

The laser emitting section 32 emits reflected laser beams toward the ABSs of the upper and lower magnetic heads 14. The structure of the laser emitting section 32 of the present embodiment is the same as that shown in FIGS. 6 and 7. Note that, in the first and the second embodiments, the reflected laser beams sweep the ABS of the magnetic head 14. In the present embodiment, the magnetic head 14 is heated in a resting state, so the ABS is entirely irradiated with the reflected laser beams. In some cases, the periphery of the read/write element of the magnetic head 14, on which contaminations easily stick, may be locally heated instead of heating the entire ABS.

In the heating/cleaning mechanism of the present embodiment, the laser emitting section 32 emits the reflected laser beams toward the magnetic heads 14 and the air introduced from the air inlets 23 is discharged form the air outlet 24 toward the ABSs of the magnetic heads 14 when the magnetic heads 14 are held, by the ramp 20, at the evacuating position. By irradiating the ABSs of the magnetic heads 14 with the reflected laser beams, contaminations, e.g., lubricant, sticking on the ABSs can be softened, and then spattered by the air discharged from the air outlet 24, so that the outer faces of the magnetic heads 14 can be cleaned.

After the magnetic heads 14 are moved to the evacuating position, the magnetic recording medium 12 is rotated for a prescribed time period, so the magnetic heads 14 can be cleaned while rotating the magnetic recording medium 12. Further, when the magnetic heads 14 are moved from the unloading position to the loading position on the magnetic recording medium 12, the rotation of the magnetic recording medium 12 is started and air streams are generated, so that the magnetic heads 14 can be cleaned before loading. It is effective to provide the contamination filters 50e to the ramp 20.

The magnetic disk device, in which the magnetic heads 14 are loaded on the both surfaces of the magnetic recording medium 12, has been explained. In case of loading the magnetic head 14 onto one surface of the magnetic recording medium 12 too, the outer face of the magnetic head 14 can be cleaned at the evacuating position by the similar structure. In this case, the laser emitting section 32 emits the reflected laser beams toward the outer face of the magnetic head located at the evacuating position, and the air introduced by the air inlet 23 is discharged toward the outer face (ABS) of the magnetic head 14 from the air outlet 24.

In FIGS. 12A-12C, a heading of the ramp 20 can be turned according to the states of the magnetic head 14, i.e., the unloading state and the loading state. The ramp 20 can be horizontally turned about a shaft 28. FIG. 12A shows the unloading state; FIG. 12B shows the loading state. When the magnetic head 14 is in the unloading state, the ramp 20 is turned to extend the air inlets 23 beyond the outer edge of the magnetic recording medium 12. This position is a cleaning position (see FIG. 12A). On the other hand, when the magnetic head 14 is in the loading state, the ramp 20 is turned to an evacuating position of the ramp 20, which is located outside of the magnetic recording medium 12, so as not to interfere with the outer edge of the magnetic recording medium 12 (see FIG. 12B).

By turning the ramp 20, the ramp 20 never badly influences actions of the magnetic head 14, etc. while loading the magnetic head 14.

When the magnetic head 14 is located at the evacuating position in the ramp 20, contaminations can be effectively removed from the ABS of the magnetic head 14 by heating the magnetic head 14 and using the air stream or wind pressure. In comparison with the first and the second embodiments in each of which the magnetic head 14 is heated while the magnetic head 14 is moved across the laser emitting section 32, enough time can be spent to clean the magnetic head 14 at the evacuating position in the third embodiment.

It is effective to use the air stream while the magnetic head 14 is located at the evacuating position. In another case, the magnetic head 14 may be cleaned, at the evacuating position, by merely heating the magnetic head 14 with the laser emitting section 32 without using the air steam. In this case, the magnetic head 14 is heated before loading onto the magnetic recording medium 12, and the softened contaminations are spattered and removed from the ABS of the magnetic head 14 by the air stream generated by the rotation of the magnetic recording medium 12 when the magnetic head 14 is loaded. Therefore, a conventional ramp may be used.

As described above, in the magnetic disk device of the present invention, contaminations sticking on the outer face of the magnetic head can be removed by heating the magnetic head with laser beams and spattering the softened contaminations with the air stream or wind pressure, which is generated by the rotation of the magnetic recording medium. Therefore, the magnetic head can be cleaned without being brought into contact with a cleaning pad, so that damaging the magnetic head can be prevented.

The magnetic head can be repeatedly cleaned when the magnetic head is loaded onto the magnetic recording medium. Namely, the magnetic head can be always maintained clean. Therefore, even if a floating height of the magnetic head is very low, the magnetic head can be precisely floated, superior reading and reproducing characteristics of the magnetic head can be maintained and reliability of the magnetic disk device can be improved.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetic disk device,
comprising:
a ramp for holding a magnetic head at an evacuating position, the ramp being located outside of a region in which a magnetic recording medium is provided; and
a laser emitting section for emitting a laser beam toward an outer face of the magnetic head so as to heat the outer face thereof, the laser emitting section being located in a moving track of the magnetic head, which is moved between the evacuating position and a loading position at which the magnetic head is loaded on the magnetic recording medium, without interfering the moving action of the magnetic head,
wherein an air stream generated by rotation of the magnetic recording medium removes a contamination on the outer face of the magnetic head when the magnetic head is loaded on the magnetic recording medium.

2. A magnetic disk device,
comprising:
a ramp for holding a magnetic head at an evacuating position, the ramp being located outside of a region in which a magnetic recording medium is provided;
a laser emitting section for emitting a laser beam toward an outer face of the magnetic head so as to heat the outer face thereof, the laser emitting section being located at the evacuating position;
an air inlet for introducing an air stream, which is generated by rotation of the magnetic recording medium, to the ramp; and
an air outlet for discharging the air, which has been introduced to the ramp, toward the outer face of the magnetic head held at the evacuating position.

3. The magnetic disk device according to claim 2,
wherein the ramp is capable of moving between a cleaning position, at which the air inlet is located above an outer edge of the magnetic recording medium when the magnetic head is unloaded, and an evacuating position, at which the air inlet is separated from the outer edge of the magnetic recording medium when the magnetic head is loaded.

4. The magnetic disk device according to claim 2,
wherein the air inlet is provided in the vicinity of the outer edge of the magnetic recording medium.

5. The magnetic disk device according to claim 2,
wherein the magnetic disk device includes one or a plurality of the magnetic recording mediums,
a plurality of the magnetic heads are respectively loaded on the both surfaces of each of the magnetic recording mediums, and
a plurality of the air inlets are respectively provided in the vicinity of the upper and lower edges of each of the magnetic recording mediums.

6. The magnetic disk device according to claim 1,
wherein the magnetic disk device includes a plurality of the magnetic recording mediums,
a plurality of the magnetic heads are respectively provided for the magnetic recording mediums, and
a plurality of the laser emitting sections are respectively provided for the magnetic heads.

7. The magnetic disk device according to claim 2,
wherein the magnetic disk device includes a plurality of the magnetic recording mediums,
a plurality of the magnetic heads are respectively provided for the magnetic recording mediums, and
a plurality of the laser emitting sections are respectively provided for the magnetic heads.

8. The magnetic disk device according to claim 1,
wherein the magnetic disk device includes one or a plurality of the magnetic recording mediums,
a plurality of the magnetic heads are respectively loaded on the both surfaces of each of the magnetic recording mediums, and
the air inlet is provided for each pair of the magnetic heads to be loaded on each of the magnetic recording mediums.

9. The magnetic disk device according to claim 2,
wherein the magnetic disk device includes one or a plurality of the magnetic recording mediums,
a plurality of the magnetic heads are respectively loaded on the both surfaces of each of the magnetic recording mediums, and
the air inlet is provided for each pair of the magnetic heads to be loaded on each of the magnetic recording mediums.

10. The magnetic disk device according to claim 8,
wherein the laser emitting section emits the laser beam toward each pair of the magnetic heads to be loaded on each of the magnetic recording mediums.

11. The magnetic disk device according to claim 9,
wherein the laser emitting section emits the laser beam toward each pair of the magnetic heads to be loaded on each of the magnetic recording mediums.

12. The magnetic disk device according to claim 1,
wherein a laser emitting range of the laser emitting section is designed to irradiate an entire air bearing surface of the magnetic head.

13. The magnetic disk device according to claim 1,
wherein the laser emitting section emits the laser beam to irradiate a part of the magnetic head including a read/write element.

14. The magnetic disk device according to claim 2,
wherein the laser emitting section emits the laser beam to irradiate a part of the magnetic head including a read/write element.

15. The magnetic disk device according to claim 1,
wherein the laser emitting section is connected to a laser source by laser guide means.

16. The magnetic disk device according to claim 2,
wherein the laser emitting section is connected to a laser source by laser guide means.

17. The magnetic disk device according to claim 15,
wherein the laser source is a laser source for thermal assist.

18. The magnetic disk device according to claim 16,
wherein the laser source is a laser source for thermal assist.

19. The magnetic disk device according to claim 1,
further comprising a contamination collecting member being capable of collecting the contamination spattered from the magnetic head.

20. The magnetic disk device according to claim 2,
further comprising a contamination collecting member being capable of collecting the contamination spattered from the magnetic head.
